(19) United States
(12) Patent Application Publication
(10) Pub. No.: US 2026/0183594 A1
(43) Pub. Date: Jul. 2, 2026

(54) MEDIATOR, PREPARATION METHOD AND USE THEREOF

(71) Applicant: Zhong Huan Qi Rui Technology Development Co., Ltd. (Chengdu), Chengdu (CN)

(72) Inventors: Bo LI, Chengdu (CN); Shaodong XIE, Chengdu (CN); Xinrui LI, Chengdu (CN)

(21) Appl. No.: 19/429,455

(22) Filed: Dec. 22, 2025

(30) Foreign Application Priority Data
Jan. 2, 2025 (CN) 202510003203.4

(51) Int. Cl. A62D 3/32; A62D 101/20

(52) U.S. Cl. CPC A62D 3/32; A62D 2101/20

(57) ABSTRACT

Provided are a mediator, a preparation method and use thereof. The mediator includes the following components, in percentage by mass: 5-50% of a magnesium salt, 3-40% of a manganese salt, 5-30% of a rare earth compound, and 6-60% of an auxiliary metal salt, where the magnesium salt and the manganese salt each have vacancy defects.

### CROSS REFERENCE TO RELATED APPLICATION

This patent application claims the benefit and priority of Chinese Patent Application No. 202510003203.4 filed with the China National Intellectual Property Administration on Jan. 2, 2025, and entitled with “MEDIATOR, PREPARATION METHOD AND USE THEREOF”, the disclosure of which is incorporated by reference herein in its entirety as part of the present application.

### TECHNICAL FIELD

The present disclosure belongs to the technical field of organic contaminant treatment, and in particular relates to a mediator, and a preparation method and use thereof.

### BACKGROUND

Singlet oxygen (¹O₂) is an emerging reactive oxygen species (ROS) known for its active chemical property and instability. Singlet oxygen is widely present in nature and is one of the most frequently involved reactive oxygen species in fields such as chemistry, environmental science, and medicine. It has characteristics such as strong oxidizing capacity, high reactivity, short survival time, and no generation of toxic or harmful by-products after oxidation, and is considered a green and environmentally friendly oxidant.

However, non-free radical pathways, such as the singlet oxygen, are mostly concentrated on the surface of a mediator, and their action sites and oxidizing capacity are somewhat limited; as a result, the independent application thereof often leads to incomplete oxidation and insufficient mineralization of complex organic contaminants.

Therefore, there is an urgent need for a mediator capable of achieving complete decomposition of complex organic contaminants.

### SUMMARY

Objects of the present disclosure are to provide a mediator, a preparation method and use thereof. The mediator provided by the present disclosure can efficiently activate peroxide bridge compounds to produce singlet oxygen and free radical clusters, thereby improving degradation capability for organic contaminants.

To achieve the objects described above, the present disclosure provides the following technical solutions:

The present disclosure provides a mediator, including the following components, in percentage by mass:
5-50% of a magnesium salt, 3-40% of a manganese salt, 5-30% of a rare earth compound, and 6-60% of an auxiliary metal salt,
where the magnesium salt and the manganese salt each have vacancy defects.

In some embodiments, the magnesium salt includes at least one selected from the group consisting of magnesium valproate and magnesium pyruvate.

In some embodiments, the manganese salt includes one or more selected from the group consisting of sodium permanganate, manganese phosphate, and manganese carbonate.

In some embodiments, the rare earth compound includes at least one selected from the group consisting of a rare earth oxide and a rare earth chloride;
the rare earth oxide includes one or more selected from the group consisting of La₂O₃, Y₂O₃, Nd₂O₃, CeO₂, Sm₂O₃ and Tm₂O₃; and the rare earth chloride includes one or more selected from the group consisting of LaCl₃, RuCl₃, SmCl₃, CeCl₃, YdCl₃ and NdCl₃.

In some embodiments, the auxiliary metal salt includes one or more selected from the group consisting of calcium formate, magnesium sulfate, and potassium phosphate.

The present disclosure further provides a method for preparing the mediator described in the aforementioned technical solutions, including:
mixing components of the mediator, and subjecting a resulting mixture to wet ball milling to obtain the mediator.

In some embodiments, the wet ball milling is carried out under the following condition parameters:
a dispersant used for the wet ball milling is petroleum ether, and the petroleum ether has a boiling range of 90° C. to 120° C.; and
the wet ball milling is carried out at a rotational speed of 200 rpm to 400 rpm for 0.1 h to 2.0 h.

The present disclosure further provides use of the mediator described in the aforementioned technical solutions or the mediator prepared by the method described in the aforementioned technical solutions for degradation of organic contaminants.

In some embodiments, the use includes:
mixing the mediator with a peroxide bridge compound to obtain a mixture, and subjecting an organic contaminant to degradation treatment using the mixture,
where the mediator is the mediator described in the aforementioned technical solutions or the mediator prepared by the method described in the aforementioned technical solutions.

In some embodiments, the peroxide bridge compound includes one or more selected from the group consisting of a sodium sulfate-hydrogen peroxide-sodium chloride adduct, a sodium citrate-hydrogen peroxide-sodium chloride adduct, a sodium phosphate-hydrogen peroxide-sodium chloride adduct, potassium monopersulfate, calcium peroxide, sodium persulfate, sodium perborate, and sodium percarbonate; and
a mass ratio of the mediator to the peroxide bridge compound is in a range of 0.005-0.1:100.

The present disclosure provides a mediator, including the following components, in percentage by mass: 5-50% of a magnesium salt, 3-40% of a manganese salt, 5-30% of a rare earth compound, and 6-60% of an auxiliary metal salt, where the magnesium salt and the manganese salt each have vacancy defects. The mediator provided by the present disclosure has abundant oxygen vacancies and surface OH—, and can efficiently activate peroxide bridge compounds to produce singlet oxygen and high-energy and high-activity free radical clusters generated by synergistic mediation such as SO_{4·}—, CO_{3·}—, CL·, ·OH, HO₂·, RCOO·, and superoxide anion radicals (O₂—·), thereby greatly improving the oxidation speed and achieving more complete mineralization of organic contaminants.

The present disclosure further provides a method for preparing the mediator described in the aforementioned technical solutions. The method provided by the present disclosure is simple and rapid in process, and the reaction conditions are mild, making it suitable for industrial production.

### DETAILED DESCRIPTION OF THE EMBODIMENTS

The present disclosure provides a mediator, including the following components, in percentage by mass:
5-50% of a magnesium salt, 3-40% of a manganese salt, 5-30% of a rare earth compound, and 6-60% of an auxiliary metal salt,
where the magnesium salt and the manganese salt each have vacancy defects.

The mediator provided by the present disclosure includes, in percentage by mass, 5-50% of a magnesium salt, and specifically may be 5%, 10%, 15%, 20%, 25%, 30%, 35%, 40%, 45% or 50%. In the present disclosure, the magnesium salt has vacancy defects. In some embodiments of the present disclosure, the magnesium salt includes at least one selected from the group consisting of magnesium valproate and magnesium pyruvate.

The mediator provided by the present disclosure includes, in percentage by mass, 3-40% of a manganese salt, and specifically may be 3%, 5%, 10%, 15%, 20%, 25%, 30%, 35%, or 40%. In the present disclosure, the manganese salt has vacancy defects. In some embodiments of the present disclosure, the manganese salt includes one or more selected from the group consisting of sodium permanganate, manganese phosphate, and manganese carbonate.

The mediators provided by the present disclosure includes, in percentage by mass, 5-30% of a rare earth compound, and specifically may be 5%, 10%, 15%, 20%, 25% or 30% by mass. In some embodiments of the present disclosure, the rare earth compound includes at least one selected from the group consisting of a rare earth oxide and a rare earth chloride; the rare earth oxide includes one or more selected from the group consisting of La₂O₃, Y₂O₃, Nd₂O₃, CeO₂, Sm₂O₃ and Tm₂O₃; and the rare earth chloride includes one or more selected from the group consisting of LaCl₃, RuCl₃, SmCl₃, CeCl₃, YdCl₃ and NdCl₃.

The mediator provided by the present disclosure includes, in percentage by mass, 6-60% of an auxiliary metal salt, and specifically may be 6%, 10%, 15%, 20%, 25%, 30%, 35%, 40%, 45%, 50%, 55%, or 60%. In some embodiments of the present disclosure, the auxiliary metal salt includes one or more selected from the group consisting of calcium formate, magnesium sulfate, and potassium phosphate.

In some embodiments of the present disclosure, the mediator has a particle size of 0.5 μm to 200 μm.

The present disclosure further provides a method for preparing the mediator described in the aforementioned technical solutions, including the following steps: mixing components of the mediator, and subjecting a resulting mixture to wet ball milling to obtain the mediator.

In some embodiments of the present disclosure, the wet ball milling is carried out under the following condition parameters: a dispersant used for the wet ball milling is petroleum ether, and the petroleum ether has a boiling range of 90° C. to 120° C.; and the wet ball milling is carried out at a rotational speed of 200 rpm to 400 rpm for 0.1 h to 2.0 h. In some embodiments of the present disclosure, the wet ball milling is carried out under a nitrogen atmosphere, and the wet ball milling is carried out in a rotary ball mill.

In some embodiments of the present disclosure, after the wet ball milling, the method further includes subjecting a resulting system to filtration and then drying.

The present disclosure further provides use of the mediator described in the aforementioned technical solutions or the mediator prepared by the method described in the aforementioned technical solutions for degradation of organic contaminants.

In some embodiments of the present disclosure, the use includes:
mixing a mediator with a peroxide bridge compound to obtain a mixture, and subjecting an organic contaminant to degradation treatment using the mixture,
where the mediator is the mediator described in the aforementioned technical solutions or a mediator prepared by the method described in the aforementioned technical solutions.

In some embodiments of the present disclosure, the peroxide bridge compound includes one or more selected from the group consisting of a sodium sulfate-hydrogen peroxide-sodium chloride adduct, a sodium citrate-hydrogen peroxide-sodium chloride adduct, a sodium phosphate-hydrogen peroxide-sodium chloride adduct, potassium monopersulfate, calcium peroxide, sodium persulfate, sodium perborate, and sodium percarbonate.

In the present disclosure, the organic contaminant includes one or more selected from the group consisting of an antibiotic, an organic dye, and a VOC. There is no special requirement for the form of the organic contaminant, which specifically may be a gas, solid or liquid.

In some embodiments of the present disclosure, a mass ratio of the mediator to the peroxide bridge compound is in a range of 0.005-0.1:100.

Unless otherwise specified, the materials and equipment used in the present disclosure are commercially available in the art.

The technical solutions in the present disclosure will be described clearly and completely below with reference to the examples of the present disclosure. Apparently, the described examples are merely some, rather than all of the examples of the present disclosure. Based on the examples in the present disclosure, all other examples obtained by those of ordinary skill in the art without involving creative effort belong to the scope of the present disclosure.

### Example 1

A mediator in this example consisted of the following components, in percentage by mass: 35% of magnesium valproate, 3% of sodium permanganate, 17% of manganese carbonate, 15% of La₂O₃, 20% of calcium formate, and 10% of magnesium sulfate.

Magnesium valproate, sodium permanganate, manganese carbonate, calcium formate, magnesium sulfate, and La₂O₃ were weighed and then put into a stainless steel rotary ball mill.

Petroleum ether was introduced into the rotary ball mill, and the rotary ball mill was sealed.

A ball mill jar was filled with nitrogen to exhaust air inside. A resulting mixture was subjected to ball milling at a rotational speed of 350 rpm for 0.5 h. After the ball milling, a resulting product was sequentially filtered and dried in air to obtain a mediator with an average particle size of 60 μm to 120 μm.

### Example 2

A mediator in this example consisted of the following components in percentage by mass: 30% of magnesium valproate, 4% of sodium permanganate, 19% of manganese carbonate, 16% of La₂O₃, 16% of calcium formate, and 15% of magnesium sulfate.

Magnesium valproate, sodium permanganate, manganese carbonate, calcium formate, magnesium sulfate, and La₂O₃ were weighed and then put into a stainless steel rotary ball mill.

Petroleum ether was introduced into the rotary ball mill, and the rotary ball mill was sealed.

A ball mill jar was filled with nitrogen to exhaust air inside. A resulting mixture was subjected to ball milling at a rotational speed of 330 rpm for 1.0 h. After the ball milling, a resulting product was sequentially filtered and dried in air to obtain a mediator with an average particle size of 80 μm to 150 μm.

### Performance Test

The mediator obtained in Example 1 or Example 2 was added to different peroxide bridge compounds, and the oxidation capacity before and after the addition was tested using an ORP (Oxidation Reduction Potential) in-line detector. The test was conducted as follows: a peroxide bridge compound and a mediator were mixed to prepare an aqueous solution with a mass concentration of 1%, and its ORP value was tested.

The obtained test results are shown in Table 1 and Table 2, respectively.

TABLE 1
Synergistic mediation capability of the mediator obtained in Example 1

| | ORP | ORP value |
|---|---|---|
| | value of | after addition |
| Composition of different peroxide | 1% aqueous | of 0.03 wt % of the |
| bridge compounds | solution/mV | mediator/mV |
| Sodium sulfate-hydrogen peroxide- | 520 | 1750 |
| sodium chloride adduct | | |
| Potassium monopersulfate complex | 640 | 2400 |
| salt | | |
| Sodium percarbonate | 430 | 1400 |
| Sodium sulfate-hydrogen peroxide- | 770 | 2860 |
| sodium chloride adduct (50%) + | | |
| potassium monopersulfate complex | | |
| salt (50%) | | |
| Sodium citrate-hydrogen peroxide- | 710 | 1800 |
| sodium chloride adduct (40%) + | | |
| calcium peroxide (60%) | | |
| Potassium monopersulfate complex | 750 | 2520 |
| salt (55%) + sodium percarbonate | | |
| (45%) | | |

TABLE 2
Synergistic mediation capability of the mediator obtained in Example 2

| | ORP | ORP value |
|---|---|---|
| | value of | after addition |
| Composition of different peroxide | 1% aqueous | of 0.03 wt % of the |
| bridge compounds | solution/m V | mediator/m V |
| Sodium sulfate-hydrogen peroxide- | 520 | 1700 |
| sodium chloride adduct | | |
| Potassium monopersulfate complex | 640 | 2350 |
| salt | | |
| Sodium percarbonate | 430 | 1450 |
| Sodium sulfate-hydrogen peroxide- | 770 | 2800 |
| sodium chloride adduct (50%) + | | |
| potassium monopersulfate complex | | |
| salt (50%) | | |
| Sodium citrate-hydrogen peroxide- | 710 | 1760 |
| sodium chloride adduct (40%) + | | |
| calcium peroxide (60%) | | |
| Potassium monopersulfate complex | 750 | 2600 |
| salt (55%) + sodium percarbonate | | |
| (45%) | | |

As can be seen from Table 1 and Table 2, the oxidation capacity of the peroxide bridge compounds is greatly enhanced upon addition of the mediators provided by the present disclosure, and the high ORP values represent a strong degradation capability for organic contaminants.

Although the embodiments described above have provided a detailed description of the present disclosure, they are only a part of, rather than all of the embodiments of the present disclosure. All other embodiments that can be obtained according to the embodiments of the present disclosure without creative efforts, shall fall within the scope of the present disclosure.

What is claimed is:

1. A mediator, comprising the following components, in percentage by mass:
5-50% of a magnesium salt, 3-40% of a manganese salt, 5-30% of a rare earth compound, and 6-60% of an auxiliary metal salt,
wherein the magnesium salt and the manganese salt each have vacancy defects.

2. The mediator of claim 1, wherein the magnesium salt comprises at least one selected from the group consisting of magnesium valproate and magnesium pyruvate.

3. The mediator of claim 1, wherein the manganese salt comprises one or more selected from the group consisting of sodium permanganate, manganese phosphate, and manganese carbonate.

4. The mediator of claim 1, wherein the rare earth compound comprises at least one selected from the group consisting of a rare earth oxide and a rare earth chloride;
the rare earth oxide comprises one or more selected from the group consisting of La₂O₃, Y₂O₃, Nd₂O₃, CeO₂, Sm₂O₃, and Tm₂O₃; and
the rare earth chloride comprises one or more selected from the group consisting of LaCl₃, RuCl₃, SmCl₃, CeCl₃, YdCl₃, and NdCl₃.

5. The mediator of claim 1, wherein the auxiliary metal salt comprises one or more selected from the group consisting of calcium formate, magnesium sulfate, and potassium phosphate.

6. A method for preparing the mediator of claim 1, comprising:
mixing components of the mediator, and subjecting a resulting mixture to wet ball milling to obtain the mediator.

7. The method of claim 6, wherein the wet ball milling is carried out under the following condition parameters:
a dispersant used for the wet ball milling is petroleum ether, and the petroleum ether has a boiling range of 90° C. to 120° C.; and
the wet ball milling is carried out at a rotational speed of 200 rpm to 400 rpm for 0.1 hours to 2.0 hours.

8. A process for degradation of organic contaminants, comprising:
mixing the mediator of claim 1 with a peroxide bridge compound to obtain a mixture, and subjecting an organic contaminant to degradation treatment using the mixture.

9. The process of claim 8, wherein the peroxide bridge compound comprises one or more selected from the group consisting of a sodium sulfate-hydrogen peroxide-sodium chloride adduct, a sodium citrate-hydrogen peroxide-sodium chloride adduct, a sodium phosphate-hydrogen peroxide-sodium chloride adduct, potassium monopersulfate, calcium peroxide, sodium persulfate, sodium perborate and sodium percarbonate; and
a mass ratio of the mediator to the peroxide bridge compound is in a range of 0.005-0.1:100.

10. The method of claim 6, wherein the magnesium salt comprises at least one selected from the group consisting of magnesium valproate and magnesium pyruvate.

11. The method of claim 6, wherein the manganese salt comprises one or more selected from the group consisting of sodium permanganate, manganese phosphate, and manganese carbonate.

12. The method of claim 6, wherein the rare earth compound comprises at least one selected from the group consisting of a rare earth oxide and a rare earth chloride;
the rare earth oxide comprises one or more selected from the group consisting of La₂O₃, Y₂O₃, Nd₂O₃, CeO₂, Sm₂O₃, and Tm₂O₃; and
the rare earth chloride comprises one or more selected from the group consisting of LaCl₃, RuCl₃, SmCl₃, CeCl₃, YdCl₃, and NdCl₃.

13. The method of claim 6, wherein the rare earth compound comprises at least one selected from the group consisting of a rare earth oxide and a rare earth chloride;
the rare earth oxide comprises one or more selected from the group consisting of La₂O₃, Y₂O₃, Nd₂O₃, CeO₂, Sm₂O₃, and Tm₂O₃; and
the rare earth chloride comprises one or more selected from the group consisting of LaCl₃, RuCl₃, SmCl₃, CeCl₃, YdCl₃, and NdCl₃.
